(19) United States
(12) Patent Application Publication
(10) Pub. No.: US 2017/0127695 A1
(43) Pub. Date: May 11, 2017

(54) MELT-RESTRICTED, NATURAL CHEESE AND METHOD OF MAKING THE SAME

(71) Applicant: Sargento Foods Inc., Plymouth, WI (US)

(72) Inventor: Mihir Sainani, Plymouth, WI (US)

(21) Appl. No.: 15/348,898

(22) Filed: Nov. 10, 2016

Related U.S. Application Data
(60) Provisional application No. 62/253,603, filed on Nov. 10, 2015.

(51) Int. Cl. A23C 19/068; A23C 19/05; A23C 19/064; A23C 19/045

(52) U.S. Cl. CPC A23C 19/068; A23C 19/045; A23C 19/05; A23C 19/064

(57) ABSTRACT

Disclosed herein are melt-restricted, natural cheeses, and methods of providing melt-restricted, natural cheeses.

### CROSS-REFERENCE TO RELATED APPLICATIONS

This application claims priority to U.S. Provisional Application No. 62/253,603 filed on Nov. 10, 2015, which is incorporated fully herein by reference.

### TECHNICAL FIELD

The present disclosure relates generally to natural cheeses, and more particularly to melt-restricted, natural cheeses.

### BACKGROUND

Melt restricted, natural cheeses that possess a pH of greater than 6 may present food safety concerns. Additionally, the introduction of homogenization to produce melt-restricted, natural cheeses, can lead to increased costs and decreased efficiency during the cheese making process. Thus, there is a need for natural, melt-restricted cheeses that have a lower pH, which can increase food safety of the cheese, which may be produced without homogenization.

### SUMMARY

In one aspect, disclosed herein is a melt-restricted, natural cheese comprising a pH of less than 6.

In another aspect, disclosed herein is a melt-restricted, natural cheese comprising a pH of from greater than 4.6 to about 5.6; protein in an amount of about 26 wt % to about 32 wt %; salt in an amount of about 1.7 wt % to about 2.4 wt %; fat in an amount of about 20 wt % to about 28 wt %; a moisture content in an amount of about 38 wt % to about 45 wt %; and salt in the moisture phase in an amount of about 4 wt % to about 6 wt %.

In another aspect, disclosed herein is a method for making a melt-restricted, natural cheese, the method comprising: (a) providing a milk composition with a fat:casein ratio of from about 0.8 to about 1.0; (b) heating the milk composition at a temperature from about 180° F. to about 190° F.; (c) contacting the milk composition with at least one salt-sensitive culture and a low proteolytic enzyme for a period of time to form a coagulated milk composition; (d) cooking the coagulated milk composition at a temperature from about 110° F. to about 120° F.; (e) removing the whey from the coagulated milk composition; and (f) salting and pressing the coagulated milk composition to provide a melt-restricted, natural cheese.

### BRIEF DESCRIPTION OF THE DRAWINGS

FIG. 1 shows images of conventional natural cheeses evaluated for melt characteristics. Six cheeses are shown as a composite of pre-bake image (on the left) and a post-bake image (on the right).

FIG. 2 shows images of a disclosed melt-restricted, natural cheese evaluated for melt characteristics. A: pre-bake; B: post-bake; and C: side-by-side comparison. The dashed line of the post-bake melt-restricted cheese is only used as a means to better visualize said cheese.

FIG. 3 shows images of a shelf-life evaluation for a disclosed melt-restricted natural cheese. The different images correspond to days of aging prior to being evaluated: A: 30 days aged no melt analysis; the remaining images show evaluated cheese samples: B: 30 days aged; C: 60 days aged; D: 90 days aged; E: 120 days aged; and F: 150 days aged.

### DETAILED DESCRIPTION

Disclosed herein are natural cheeses that maintain their form at elevated temperatures and do not flow. Also disclosed herein are methods of making the natural cheese. Typical natural cheeses melt at temperatures ranging from about 130° F. (e.g., mozzarella) to about 150° F. (e.g., cheddar). Nonetheless, there are instances where a cheese is desired to remain form-stable when exposed to temperatures above the aforementioned conventional melt temperatures, for example, in the use of baked cheeses. Currently, natural cheeses that fail to flow at elevated temperatures typically are acidic (e.g., pH˜4.6) or have a higher pH (e.g., pH>6), or are produced using a homogenization process. The higher pH aids in casein/calcium phosphate interactions, which results in the cheese being more form-stable at higher temperatures. In addition, homogenizing the fat globules of the milk composition decreases fat globule size, which may also result in a form-stable cheese at higher temperatures.

The disclosed melt-restricted, natural cheeses may have a lower pH compared to other natural melt-restricted cheeses. Furthermore, the disclosed melt-restricted, natural cheeses may be provided without homogenizing the milk composition.

It has been discovered that a melt-restricted, natural cheese may be provided by modulating elements of the cheese making process. For example, by modulating one or more of the pasteurization temperature, fat: casein ratio, type of culture, type of rennet, and pH, a melt-restricted, natural cheese can be provided. Accordingly, by regulating one or more of the aforementioned elements, and without using a high pH, the disclosed melt-restricted, natural cheeses are provided with increased efficiency and a higher degree of food safety.

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The term “natural cheese”, as used herein, refers to a cheese that contains only natural ingredients, such as milk, salt, fermentation cultures, water, rennet, vegetables, peppers (e.g., jalapenos), and natural flavors. Natural cheese does not contain salt substitutes, emulsifiers, vegetable oils, food coloring, or additional starches and/or sugars that are not contained within the original milk composition.

The term “conventional natural cheese”, as used herein, refers to a natural cheese as described above, which is not melt-restricted, and flows at elevated temperatures. A conventional natural cheese may have a melt spread of greater than 3 pursuant to the melt test as described herein.

The term “conventional melt-restricted, natural cheese”, as used herein, refers to a natural cheese as described above, which is also melt-restricted and has a pH of approximately 4.6 or a pH of above 6.

The term “melt-restricted, natural cheese”, as used herein, refers to a natural cheese that resists melting at elevated temperatures. In other words, a melt-restricted, natural cheese fails to flow and retains its shape at elevated temperatures, where conventional natural cheese melts and/or flows at the same elevated temperature. The melt-restricted, natural cheese may have a melt spread of less than 3 pursuant to the melt test as described herein.

The term “modulate”, as used herein, refers to increase or decrease.

The term “low proteolytic enzyme”, as used herein, refers to an enzyme that has a low reaction rate for cleaving chemical bonds within casein. For example, a low proteolytic enzyme can better maintain the integrity of casein/casein interactions, compared to a conventional proteolytic enzyme.

The term “salt-sensitive culture”, as used herein, refers to a culture used in the fermentation of milk, wherein the culture is sensitive to the presence of salt. For example, increasing salt content (e.g. NaCl) within the coagulated milk composition (e.g., curd), may increase or decrease the metabolism of the salt-sensitive culture. In some instances, this modulation of metabolism can alter lactose to lactic acid conversion, which can modulate the pH of the coagulated milk composition.

The term “shelf-life”, as used herein, refers to the time (post-production) for which the melt-restricted, natural cheese still comprises the requisite physical and organoleptic characteristics for sale and/or consumption.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. MELT-RESTRICTED, NATURAL CHEESE

Disclosed herein are melt-restricted, natural cheeses that can be heated to elevated temperatures while still retaining their form. The melt-restricted, natural cheeses can withstand elevated temperatures without flowing, while still possessing the composition of a natural cheese. Accordingly, the disclosed melt-restricted cheeses do not comprise emulsifying agents, vegetable oils, food coloring, or additional starches and/or sugars that are not contained within the original milk composition. In addition, the melt-restricted, natural cheeses have a lower pH, compared to some conventional melt-restricted, natural cheeses.

The melt-restricted, natural cheese comprises a moisture content, pH, fat, salt, and protein. One or more of the moisture content, pH, fat, salt, and protein may contribute to the melt-resistant properties of the melt-restricted cheeses. In addition, the melt-restricted, natural cheese may have an enhanced shelf-life compared to other non-melting cheeses.

The melt-restricted, natural cheese may be easier to process after being made relative to other melt-restricted cheeses. For example, the disclosed melt-restricted, natural cheese may be easily sliced and/or processed to different shapes which then can be easily packaged for sale. In contrast, melt-restricted cheese, such as queso blanco, suffers from being brittle when being sliced or processed to different shapes, which may create difficulty in packaging said cheese.

The melt-restricted, natural cheese may be useful in a variety of food products, for example, meat patties or sausages. The melt-restricted, natural cheese may be useful as an ingredient within other cheese(s) and/or cheese products. The melt-restricted, natural cheese may be useful as a snack product, for example, as cubed cheese snacks. The melt-restricted, natural cheese may be useful for grilling. Additionally, the melt-restricted, natural cheese may be useful as a replacement for bread products (e.g., hot dog /hamburger buns), tortilla shells, and pizza crust.

a. Moisture Content

The melt-restricted, natural cheese comprises a moisture content. The melt-restricted, natural cheese may comprise a moisture content in an amount of about 35 wt % to about 48 wt %. In some embodiments, the melt-restricted, natural cheese may comprise a moisture content in an amount of about 38 wt % to about 45 wt %. In some embodiments, the melt-restricted, natural cheese may comprise a moisture content in an amount of about 40 wt % to about 45 wt %. For example, the melt-restricted, natural cheese may comprise a moisture content in an amount of about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, or about 48 wt %.

In some embodiments, the melt-restricted, natural cheese may comprise a moisture content in an amount of greater than 35 wt %, greater than 36 wt %, greater than 37 wt %, greater than 38 wt %, greater than 39 wt %, greater than 40 wt %, greater than 41 wt %, greater than 42 wt %, greater than 43 wt %, or greater than 44 wt %.

In some embodiments, the melt-restricted, natural cheese may comprise a moisture content in an amount of less than 50 wt %, less than 49 wt %, less than 48 wt %, less than 47 wt %, less than 46 wt %, or less than 45 wt %.

b. pH

The melt-restricted, natural cheese comprises a pH value. The melt-restricted, natural cheese may comprise a pH in the range of greater than 4.6 to about 5.9. In some embodiments, the melt-restricted, natural cheese may comprise a pH in the range of greater than 4.6 to about 5.8. In some embodiments, the melt-restricted, natural cheese may comprise a pH in the range of greater than 4.6 to about 5.6. For example, the melt-restricted, natural cheese may comprise a pH of about 4.7, about 4.8, about 4.9, about 5.0, about 5.1, about 5.2, about 5.3, about 5.4, about 5.5, or about 5.6.

In some embodiments, the melt-restricted, natural cheese may comprise a pH less than 5.7, or less than 5.6. In some embodiments, the melt-restricted, natural cheese may comprise a pH greater than 4.6, greater than 4.7, greater than 4.8, greater than 4.9, or greater than 5.

c. Fat

The melt-restricted, natural cheese comprises fat. In some embodiments, the fat of the melt-restricted, natural cheese has not been homogenized. The melt-restricted, natural cheese may comprise fat in an amount of about 15 wt % to about 30 wt %. In some embodiments, the melt-restricted, natural cheese may comprise fat in an amount of about 18 wt % to about 24 wt %. In some embodiments, the melt-restricted, natural cheese may comprise fat in an amount of about 20 wt % to about 28 wt %. For example, the melt-restricted, natural cheese may comprise fat in an amount of about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt %.

In some embodiments, the melt-restricted, natural cheese may comprise fat in an amount of greater than 15 wt %, greater than 16 wt %, greater than 17 wt %, greater than 18 wt %, greater than 19 wt %, greater than 20 wt %, greater than 21 wt %, or greater than 22 wt %.

In some embodiments, the melt-restricted, natural cheese may comprise fat in an amount of less than 30 wt %, less than 25 wt %, less than 24 wt %, less than 23 wt %, less than 22 wt %, less than 21 wt %, or less than 20 wt %.

i. Fat Dry Basis (FDB)

The melt-restricted, natural cheese comprises a FDB, wherein FDB and fat in dry matter (FDM) are used interchangeably. The FDB of a cheese may be calculated as a percentage. For example, FDB may be calculated as the fat wt % of the cheese divided by the solid percentage (e.g., 100%—moisture %) of the same cheese.

The melt-restricted, natural cheese may comprise a FDB of about 35 wt % to about 45 wt % or about 38 wt % to about 45 wt %. For example, the melt-restricted, natural cheese may comprise a FDB of about 35 wt %, about 36 wt %, about 37 wt %, about 38 wt %, about 39 wt %, about 40 wt %, about 41 wt %, about 42 wt %, about 43 wt %, about 44 wt % or about 45 wt %. In some embodiments, the melt-restricted, natural cheese may comprise a FDB of greater than 35 wt %, greater than 36 wt %, greater than 37 wt %, greater than 38 wt % or greater than 39 wt %. In other embodiments, the melt-restricted, natural cheese may comprise a FDB of less than 45 wt %.

ii. FDB/Moisture Content Ratio

The melt-restricted, natural cheese comprises a FDB/moisture content ratio. The FDB/moisture content ratio, in combination with other disclosed properties, may be useful in providing melt-restricted, natural cheeses.

The melt-restricted, natural cheese may comprise a FDB/moisture content ratio of about 0.8 to about 1.2. For instance, the melt-restricted, natural cheese may comprise a FDB/moisture content ratio of about 0.8, about 0.85, about 0.9, about 0.95, about 1.0, about 1.05, about 1.1, about 1.15, or about 1.2. In some embodiments, the melt-restricted, natural cheese may comprise a FDB/moisture content ratio of greater than 0.8, greater than 0.85, greater than 0.9, or greater than 0.95. In other embodiments, the melt-restricted, natural cheese may comprise a FDB/moisture content ratio of less than 1.2, less than 1.15, or less than 1.1.

d. Salt

The melt-restricted, natural cheese comprises salt. The salt may be sodium chloride. The melt-restricted, natural cheese does not comprise salt substitutes or other artificial salt additives. The melt-restricted, natural cheese may comprise salt in an amount of about 1.0 wt % to about 2.5 wt %. In some embodiments, the melt-restricted, natural cheese may comprise salt in an amount of about 1.7 wt % to about 2.4 wt %. In some embodiments, the melt-restricted, natural cheese may comprise salt in an amount of about 1.8 wt % to about 2.4 wt %. For example, the melt-restricted, natural cheese may comprise salt in an amount of about 1.0 wt %, about 1.05 wt %, about 1.10 wt %, about 1.15 wt %, about 1.2 wt %, about 1.25 wt %, about 1.3 wt %, about 1.35 wt %, about 1.4 wt %, about 1.45 wt %, about 1.5 wt %, about 1.55 wt %, about 1.6 wt %, about 1.65 wt %, about 1.7 wt %, about 1.75 wt %, about 1.8 wt %, about 1.85 wt %, about 1.9 wt %, about 1.95 wt %, about 2.0 wt %, about 2.05 wt %, about 2.1 wt %, about 2.15 wt %, about 2.2 wt %, about 2.25 wt %, about 2.3 wt %, about 2.35 wt %, about 2.4 wt %, about 2.45 wt %, or about 2.5 wt %.

In some embodiments, the melt-restricted, natural cheese may comprise salt in an amount of greater than 1.0 wt %, greater than 1.1 wt %, greater than 1.2 wt %, greater than 1.3 wt %, greater than 1.4 wt %, greater than 1.5 wt %, greater than 1.55 wt %, greater than 1.6 wt %, greater than 1.65 wt %, greater than 1.7 wt %, greater than 1.75 wt %, greater than 1.8 wt %, greater than 1.85 wt %, or greater than 1.9 wt %.

In some embodiments, the melt-restricted, natural cheese may comprise salt in an amount of less than 2.5 wt %, less than 2.0 wt %, less than 1.95 wt %, less than 1.90 wt %, less than 1.85 wt %, less than 1.8 wt %, or less than 1.75 wt %.

i. Salt in the Moisture Phase

The melt-restricted, natural cheese may comprise salt in the moisture phase of the cheese. The salt in the moisture phase may be sodium chloride. The amount of salt in the moisture phase, in combination with other disclosed properties, may be useful in providing melt-restricted, natural cheeses. The amount of salt in the moisture phase of a cheese may be reported as a percentage. For example, the percentage of salt in the moisture phase may be calculated by dividing the salt wt % of a cheese by the moisture content wt % of the same cheese, thereby providing the percentage of salt within the moisture phase.

The melt-restricted, natural cheese may comprise salt in the moisture phase in an amount of about 4 wt % to about 6.2 wt % or about 4.3 wt % to about 6 wt %. For instance, the melt-restricted, natural cheese may comprise salt in the moisture phase in an amount of about 4 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6 wt %, about 6.1 wt %, or about 6.2 wt %.

e. Protein

The melt-restricted, natural cheese comprises protein. The protein may be milk protein. The milk protein may comprise casein and whey. In some embodiments, the melt-restricted, natural cheese may derive 100% of its protein from the initial milk composition.

The melt-restricted, natural cheese may comprise protein in an amount of about 20 wt % to about 40 wt %. In some embodiments, the melt-restricted, natural cheese may comprise protein in an amount of about 25 wt % to about 35 wt % or of about 26 wt % to about 32 wt %. In some embodiments, the melt-restricted, natural cheese may comprise protein in an amount of about 26 wt % to about 32 wt %. For example, the melt-restricted, natural cheese may comprise protein in an amount of about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, or about 40 wt %.

In some embodiments, the melt-restricted, natural cheese may comprise protein in an amount of greater than 20 wt %, greater than 21 wt %, greater than 22 wt %, greater than 23 wt %, greater than 24 wt %, greater than 25 wt %, greater than 26 wt %, greater than 27 wt %, greater than 28 wt %, greater than 29 wt %, or greater than 30 wt %.

In some embodiments, the melt-restricted, natural cheese may comprise protein in an amount of less than 35 wt %, less than 34 wt %, less than 33 wt %, less than 32 wt %, less than 31 wt %, or less than 30 wt %.

f. Shelf-Life

The melt-restricted, natural cheese may have an enhanced shelf-life, compared to conventional natural cheese. Shelf-life of the melt-restricted, natural cheese may be characterized by analyzing organoleptic features, including, but not limited to, flavor, texture and visual presentation. In addition, shelf-life may be analyzed by the presence of cultures within the cheese. For example, the melt-restricted, natural cheese may be assessed through micro-plating.

The melt-restricted, natural cheese may comprise a shelf-life of from about 4 weeks to about 20 weeks. In some embodiments, the melt-restricted, natural cheese may comprise a shelf-life of from about 4 weeks to about 30 weeks. In some embodiments, the melt-restricted, natural cheese may comprise a shelf-life of from about 4 weeks to about 20 weeks. For example, the melt-restricted, natural cheese may comprise a shelf-life of about 4 weeks, about 5 weeks, about 6 weeks, about 7 weeks, about 8 weeks, about 9 weeks, about 10 weeks, about 11 weeks, about 12 weeks, about 13 weeks, about 14 weeks, about 15 weeks, about 16 weeks, about 17 weeks, about 18 weeks, about 19 weeks, about 20 weeks, about 22 weeks, about 24 weeks, about 26 weeks, about 28 weeks or about 30 weeks.

In some embodiments, the melt-restricted, natural cheese may comprise a shelf-life of greater than 4 weeks, greater than 5 weeks, greater than 6 weeks, greater than 7 weeks, greater than 8 weeks, greater than 9 weeks, greater than 10 weeks, greater than 11 weeks, or greater than 12 weeks.

In some embodiments, the melt-restricted, natural cheese may comprise a shelf-life of less than 30 weeks, less than 20 weeks, less than 18 weeks, less than 17 weeks, less than 16 weeks, less than 15 weeks, less than 14 weeks, less than 13 weeks, or less than 12 weeks.

g. Melt-Restricted

The melt-restricted, natural cheese may be resistant to melting upon being exposed to elevated temperatures; for example, temperatures at which a conventional, natural cheese would melt. The melt test, as described herein, may be used to assess the melt-restricted properties of the melt-restricted, natural cheese. For example, Melt Test 1 or a Schreiber melt test may be used to assess melt properties of the melt-restricted, natural cheese at temperatures from about 200° F. to about 500° F. In addition, the melt-restricted, natural cheese may be held for about 1 minute to about 15 minutes at the aforementioned temperatures during the Schreiber melt test. In some embodiments, the melt-restricted, natural cheese is heated to 350° F. for 5 minutes. In other embodiments, the melt-restricted, natural cheese is heated to 425° F. for 5 minutes. Following the heating time period, the melt-restricted, natural cheese is removed from the heat source and may be allowed to cool for 30 minutes at room temperature. The melt-restricted, natural cheese is then analyzed for melt-properties such as, but not limited to, melt spread. In some embodiments, the melt-restricted, natural cheese may have a melt spread of less than 3 as verified by Melt Test 1.

In some embodiments, the melt-restricted, natural cheese is melt-restricted as verified by Melt Test 1. In some embodiments, the melt-restricted, natural cheese may melt at from about 200° F. to about 500° F. In some embodiments, the melt-restricted, natural cheese does not melt at temperatures greater than 200° F., greater than 250° F., greater than 300° F., greater than 350° F., greater than 400° F., greater than 450° F., or greater than 500° F. In some embodiments, the melt-restricted, natural cheese does not melt.

### 3. METHODS OF MAKING THE MELT-RESTRICTED, NATURAL CHEESE

Provided herein are methods of making melt-restricted, natural cheeses. The methods disclosed herein provide melt-restricted, natural cheeses that may be made without the use of homogenization, and wherein the resultant cheese may have a lower pH, compared to conventional melt-restricted, natural cheeses.

The method comprises providing a milk composition, and then transforming the milk composition to a coagulated milk composition (e.g. curd). The coagulated milk composition may then be processed by a number of different techniques to provide a melt-restricted, natural cheese. The melt-restricted, natural cheese may be provided within a time period of about 4 hours to about 9 hours from the beginning of the method. The melt-restricted, natural cheese may then be subsequently aged for flavor maturation.

a. Providing a Milk Composition

The method includes providing a milk composition. The milk may be cow's milk, sheep's milk, buffalo's milk, goat's milk, or any other suitable type of milk known within the art for making cheese. The milk composition may comprise, for example, fresh liquid milk, milk protein concentrate, concentrated skim milk, etc.

The milk composition may be standardized to provide an appropriate fat to casein ratio. The milk composition may have a fat:casein ratio of about 0.70 to about 1.20. The milk composition may have a fat:casein ration of about 0.80 to about 1.00. For example, the milk composition may have a fat:casein ratio of about 0.70, about 0.71, about 0.72, about 0.73, about 0.74, about 0.75, about 0.76, about 0.77, about 0.78, about 0.79, about 0.80, about 0.81, about 0.82, about 0.83, about 0.84, about 0.85, about 0.86, about 0.87, about 0.88, about 0.89, about 0.90, about 0.91, about 0.92, about 0.93, about 0.94, about 0.95, about 0.96, about 0.97, about 0.98, about 0.99, about 1.00, about 1.05, about 1.10, about 1.15, or about 1.20. In some embodiments, the milk composition may have a fat:casein ratio of about 0.90.

In some embodiments, the milk composition may comprise a total solids content in an amount of about 8 wt % to about 16 wt %, about 9 wt % to about 15 wt %, or about 10 wt % to about 14 wt %. The milk composition may comprise a total solids content in an amount of about 8 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9.0 wt %, about 9.1 wt %, about 9.2%, about 9.3%, about 9.4%, about 9.5%, about 9.6%, about 9.7%, about 9.8%, about 9.9%, about 10.0%, about 10.1%, about 10.2%, about 10.3%, about 10.4%, about 10.5 wt %, about 10.6 wt %, about 10.7 wt %, about 10.8 wt %, about 10.9 wt %, about 11.0 wt %, about 11.1 wt %, about 11.2 wt %, about 11.3 wt %, about 11.4 wt %, about 11.5 wt %, about 11.6 wt %, about 11.7 wt %, about 11.8 wt %, about 11.9 wt %, about 12.0 wt %, about 12.1 wt %, about 12.2 wt %, about 12.3 wt %, about 12.4 wt %, about 12.5 wt %, about 12.6 wt %, about 12.7 wt %, about 12.8 wt %, about 12.9 wt %, about 13.0 wt %, about 13.1 wt %, about 13.2 wt %, about 13.3 wt %, about 13.4 wt %, about 13.5 wt %, about 13.6 wt %, about 13.7 wt %, about 13.8 wt %, about 13.9 wt %, about 14.0 wt %, about 14.1 wt %, about 14.2 wt %, about 14.3 wt %, about 14.4 wt %, about 14.5 wt %, about 14.6 wt %, about 14.7 wt %, about 14.8 wt %, about 14.9 wt %, about 15.0 wt %, about 15.1 wt %, about 15.2 wt %, about 15.3 wt %, about 15.4 wt %, about 15.5 wt %, about 15.6 wt %, about 15.7 wt %, about 15.8 wt %, about 15.9 wt %, or about 16.0 wt %.

In some embodiments, the milk composition may comprise a total solids content in an amount of greater than 8 wt %, greater than 9 wt %, greater than 10 wt %, greater than 11 wt %, greater than 12 wt %, greater than 13 wt %, greater than 14 wt %, or greater than 15 wt %.

In some embodiments, the milk composition may comprise a total solids content in an amount of less than 16 wt %, less than 15 wt %, less than 14 wt %, less than 13 wt %, less than 12 wt %, or less than 11 wt %.

In some embodiments, the milk composition may comprise about 2 wt % to about 4 wt % fat. The milk composition may comprise about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, or about 4.0 wt % fat.

In some embodiments, the milk composition may comprise about 2 wt % to about 4 wt % protein. The milk composition may comprise about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, or about 4.0 wt % protein.

The protein of the milk composition may comprise casein. For example, the milk composition may comprise about 1.5 wt % to about 4.0 wt %, about 2.0 wt % to about 4.0 wt %, about 2.5 wt % to about 4.0 wt %, or about 3.0 wt % to about 4.0 wt % casein. The milk composition may comprise about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, or about 4.0 wt % casein.

In some embodiments, the milk composition may not be homogenized (i.e., a non-homogenized milk composition). Accordingly, the fat globule size of the milk composition will be greater compared to milk compositions that have been homogenized. For example, the milk compositions may have a fat globule size of from about 1 μm to about 15 μm or from about 2 82 m to about 10 μm. In some embodiments, the fat globules of the milk composition may have a size of greater than 1 82 m, greater than 1.25 μm, greater than 1.5 μm, or greater than 1.75 μm.

b. Heating the Milk Composition

The method may include heating the milk composition, for example to pasteurize the milk composition. In some embodiments, heating the milk composition can be done at high temperature for a short period of time (e.g., HTST pasteurization). Heating the milk composition at higher temperatures, relative to traditional pasteurization (e.g., 164° F.), agglomerates the protein within the milk composition. Thus, heating the milk composition at higher temperatures may increase interactions between κ-casein and β-lactoglobulin. These increased interactions may be advantageous in providing melt-restricted, natural cheeses.

The milk composition may be heated at a temperature from about 170° F. to about 190° F. In some embodiments, the milk composition may be heated at a temperature from about 180° F. to about 190° F. The milk composition may be heated at a temperature of about 170° F., about 171° F., about 172° F., about 173° F., about 174° F., about 175° F., about 176° F., about 177° F., about 178° F., about 179° F., about 180° F., about 181° F., about 182° F., about 183° F., about 184° F., about 185° F., about 186° F., about 187° F., about 188° F., about 189° F., or about 190° F.

As recited above, it is known within the art, that the milk composition is typically heated (e.g., pasteurized) at a temperature of approximately 164° F., which is significantly lower than the methods disclosed herein.

In some embodiments, the milk composition may be heated for about 10 seconds to about 25 seconds. For example, the milk composition may be heated at a temperature from about 170° F. to about 190° F. for about 10 seconds, about 11 seconds, about 12 seconds, about 13 seconds, about 14 seconds, about 15 seconds, about 16 seconds, about 17 seconds, about 18 seconds, about 19 seconds, about 20 seconds, about 21 seconds, about 22 seconds, about 23 seconds, about 24 seconds, or about 25 seconds.

In some embodiments, the milk composition may be heated at a temperature of 185° F. from about 10 seconds to about 25 seconds. In some embodiments, the milk composition may be heated at a temperature of 185° F. for about 19 seconds.

c. Addition of Salt-Sensitive Culture

The method may include the addition (e.g., contacting) of at least one salt-sensitive culture to the milk composition following heat treatment. The salt-sensitive cultures may instill characteristic features to the melt-restricted, natural cheese through various processes, such as, but not limited to, production of lactic acid and production of other compounds (e.g., aldehydes and ketones), which enhance cheese flavor and regulate pH.

The disclosed method has found that using salt-sensitive cultures is advantageous compared to standard cultures because the salt-sensitive cultures can modulate the pH of the resultant melt-restricted, natural cheese. The at least one salt-sensitive culture may lower the pH of the milk composition. For example, the salt-sensitive culture(s) may drop the pH of the milk composition over a period of 4 hours following contacting the milk composition with the at least one salt-sensitive culture.

In some embodiments, the pH of the milk composition starts at about 6.60 to about 6.68 and is lowered to about 6.50 to about 6.60 within about 60 minutes following contacting with the at least one salt-sensitive culture. Following the incubation time of the milk composition with the salt-sensitive culture(s) a resultant coagulated milk composition may be provided, for example a curd may be formed.

The at least one salt-sensitive culture may be a mesophilic culture, a thermophilic culture, or a combination thereof. In some embodiments, it has been found useful to use a combination of mesophilic culture and thermophilic culture. Thermophilic cultures are cultures that have a temperature growth range between about 65° F. to about 135° F. Mesophilic cultures are cultures that have a temperature growth range between about 50° F. to about 110° F. Accordingly, thermophilic cultures prefer warmer temperatures for growth, compared to mesophilic cultures. Mesophilic cultures can be further stratified into lactic acid starter bacteria, which are primarily used for producing lactic acid; and aroma producing bacteria, which are primarily used for producing carbon dioxide and flavor. Lactic acid starter bacteria include, but are not limited to, Lactococcus lactis subsp. lactis and Lactococcus lactis subsp. cremoris. Aroma producing bacteria include, but are not limited, Lactococcus lactis subsp. lactis biovar diacetylactis and Leuconostoc mesenteriodes subsp. cremoris.

The at least one salt-sensitive culture may be a combination of different salt-sensitive cultures. For example, the at least one salt-sensitive culture may be a combination of from two salt-sensitive cultures to six salt-sensitive cultures. In some embodiments, the at least one salt sensitive culture is a combination of two salt-sensitive cultures, a combination of three salt-sensitive cultures, a combination of four salt-sensitive cultures, a combination of five salt-sensitive cultures, or a combination of six salt-sensitive cultures.

The at least one salt-sensitive culture may be purchased from Chr Hansen, and in some embodiments, the salt-sensitive culture may be a combination of A-2090 and CR-319.

The milk composition may be contacted with the at least one salt-sensitive culture for about 10 minutes to about 90 minutes, about 20 minutes to about 85 minutes, or about 30 minutes to about 80 minutes prior to cutting. In some embodiments, the milk composition is contacted with the at least one salt sensitive culture for about 80 minutes, about 85 minutes or about 90 minutes prior to cutting.

d. Addition of Calcium Chloride

The method may include adding calcium chloride to the milk composition. The calcium chloride may be added to the milk composition in an amount of about 1.5x greater than used in conventional natural cheeses. For example, calcium chloride may be added as a solution in an amount of about 150 ml to about 170 ml per 100 lbs of milk, while calcium chloride added in a conventional natural cheese is typically added in an amount of about 100 ml to about 120 ml per 100 lbs of milk. In some embodiments, the calcium chloride is added about 50 minutes after the at least one salt-sensitive culture has contacted the milk composition.

e. Addition of Low Proteolytic Enzyme

The method may include adding a low proteolytic enzyme (e.g., low proteolytic rennet) to the milk composition. The low proteolytic enzyme may cleave casein. The low proteolytic enzyme may site-specificlly cleave casein, which can be useful for providing a melt-restricted, natural cheese. The low proteolytic enzyme may be CHYMAX™ M (Chr Hansen). In some embodiments, the low proteolytic enzyme may be MAXIREN® XDS (DSM). In other embodiments, the low proteolytic enzyme may be a combination of two low proteolytic enzymes.

The low proteolytic enzyme may be diluted in cold water prior to adding to the milk composition. In some embodiments, the low proteolytic enzyme may be added to the milk composition about 50 minutes to about 70 minutes after the at least one salt-sensitive culture is added to the milk composition. For example, the low proteolytic enzyme may be added to the milk composition about 50 minutes, about 51 minutes, about 52 minutes, about 53 minutes, about 54 minutes, about 55 minutes, about 56 minutes, about 57 minutes, about 58 minutes, about 59 minutes, about 60 minutes, about 61 minutes, about 62 minutes, about 63 minutes, about 64 minutes, about 65 minutes, about 66 minutes, about 67 minutes, about 68 minutes, about 69 minutes, or about 70 minutes after the at least one salt-sensitive culture is added to the milk composition. In some embodiments, the low proteolytic enzyme may be added to the milk composition about 60 minutes after the at least one salt-sensitive culture is added to the milk composition.

The milk composition may be contacted with the low proteolytic enzyme for about 10 minutes to about 30 minutes prior to cutting. In some embodiments, the milk composition is contacted with the low proteolytic enzyme for about 20 minutes, about 25 minutes, or about 30 minutes prior to cutting.

In some embodiments, the temperature at which the method is performed from addition of the salt-sensitive culture(s) to the addition of the low proteolytic enzyme is about 90° F. to about 100° F. In some embodiments, the temperature at which the method is performed from addition of the salt-sensitive culture(s) to the addition of the low proteolytic enzyme to the milk composition is about 95° F. Additionally, in some embodiments, the pH of the milk composition starts at about 6.60 to about 6.68 and is lowered to about 6.45 to about 6.50 following incubation with the low proteolytic enzyme and the at least one salt-sensitive culture.

Following the incubation time of the milk composition with the salt-sensitive culture(s) and the low proteolytic enzyme, a resultant coagulated milk composition is provided, for example a curd is formed. The coagulated milk composition may be formed in about 70 minutes to about 90 minutes after contacting the at least one salt-sensitive culture and/or in about 30 minutes to about 40 minutes after being contacted by the combination of the at least one salt-sensitive culture and low proteolytic enzyme. In some embodiments, acid is not used to provide the coagulated milk composition.

In some embodiments, the coagulated milk composition may be formed in about 80 minutes after contacting the at least one salt-sensitive culture and /or in about 35 minutes after being contacted by the combination of the at least one salt-sensitive culture and low proteolytic enzyme.

In some embodiments, the at least one salt-sensitive culture and low proteolytic enzyme may be incubated together for a time period of about 20 minutes to about 40 minutes prior to cutting the coagulated milk composition. In some embodiments, the at least one salt-sensitive culture and low proteolytic enzyme may be incubated together for a time period of about 25 minutes to about 45 minutes prior to cooking the coagulated milk composition.

f. Cutting

The method may also include cutting the coagulated milk composition. After the milk composition has been adequately coagulated, the coagulated milk composition is processed to separate the water (e.g., whey) from the coagulated milk composition (e.g., curd). Cutting the coagulated milk composition is one technique that may be used to reduce the moisture content of the coagulated milk composition.

The coagulated milk composition may be cut by hand or by mechanical means. For example, if cut by hand the coagulated milk composition may be cut by ¹/₄″ knives. The coagulated milk composition may be cut to variable sizes.

Cutting the coagulated milk composition may be done when the coagulated milk composition has a pH of about 6.30 to about 6.55, about 6.45 to about 6.54, or about 6.48 to about 6.52. For example, cutting the coagulated milk composition may be done when the coagulated milk composition has a pH of about 6.30, about 6.35, about 6.40, about 6.45, about 6.46, about 6.47, about 6.48, about 6.49, about 6.50, about 6.51, about 6.52, about 6.53, about 6.54, or about 6.55.

g. Cooking

The method may include cooking the coagulated milk composition. As recited above, following adequate coagulation of the milk composition, the whey is separated from the coagulated milk composition (e.g., curd), and cooking is a process that may be used to reduce the moisture content of the coagulated milk composition. Cooking the coagulated milk composition may be done in a vat, wherein the vat comprises a temperature-regulated jacket.

The coagulated milk composition may be cooked at from about 110° F. to about 120° F. In some embodiments, the coagulated milk composition may be cooked at from about 114° F. to about 115° F. In some embodiments, the cook temperature may start at a temperature of about 95° F. and then raised to a temperature of about 114° F. to about 115° F. in a period of about 30 minutes, and subsequently the milk composition is cooked at about 114° F. to about 115° F. for a period of time. For example, the coagulated milk composition may be cooked at a temperature from about 114° F. to about 115° F. for about 20 minutes to about 30 minutes, about 22 minutes to about 28 minutes, or about 25 minutes to about 30 minutes.

The temperature at which the coagulated milk composition is cooked may be determined by the at least one salt-sensitive culture. In addition, depending on the desired resultant cheese, the cook temperature and time may be modified to achieve the desired properties. In some embodiments, cooking the coagulated milk composition may begin from about 95 minutes to about 100 minutes after the at least one salt-sensitive culture has contacted the milk composition.

Cooking the coagulated milk composition may be done when the coagulated milk composition has a pH of about 6.20 to about 6.40, about 6.24 to about 6.30, or about 6.24 to about 6.29. For example, cooking the coagulated milk composition may be done when the coagulated milk composition has a pH of about 6.20, about 6.21, about 6.22, about 6.23, about 6.24, about 6.25, about 6.26, about 6.27, about 6.28, about 6.29, about 6.30, about 6.31, about 6.32, about 6.33, about 6.34, about 6.35, about 6.36, about 6.37, about 6.38, about 6.39, or about 6.40.

h. Removal of Whey from the Coagulated Milk Composition

The method may include removing whey from the coagulated milk composition. Removing the whey aids in removing lactose from the coagulated milk composition. Removing the whey from the coagulated milk composition may optionally include draining the whey to a curd line. In some embodiments, the whey is drained in its entirety, without stopping at the curd line. Removing the whey from the coagulated milk composition may optionally include draining about 40% to about 60%, or about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60% of the whey to the curd line. Additionally, when draining the whey from the coagulated milk composition, the jacket of the vat is kept warm, and the coagulated milk composition is broken up.

Draining of the whey to the curd line may be performed over a period of time from about 40 minutes to about 60 minutes, about 40 minutes to about 50 minutes, or about 42 minutes to about 45 minutes. For example, draining of the whey to the curd line may be performed for about 40 minutes, about 41 minutes, about 42 minutes, about 43 minutes, about 44 minutes, about 45 minutes, about 46 minutes, about 47 minutes, about 48 minutes, about 49 minutes, about 50 minutes, about 51 minutes, about 52 minutes, about 53 minutes, about 54 minutes, about 55 minutes, about 56 minutes, about 57 minutes, about 58 minutes, about 59 minutes, or about 60 minutes.

Draining the whey to the curd line may be done when the coagulated milk composition has a pH of about 6.05 to about 6.20, about 6.10 to about 6.20, or about 6.12 to about 6.16. For example, draining the whey to the curd line may be done when the coagulated milk composition has a pH of about 6.05, about 6.06, about 6.07, about 6.08, about 6.09, about 6.10, about 6.11, about 6.12, about 6.13, about 6.14, about 6.15, about 6.16, about 6.17, about 6.18, about 6.19, or about 6.20.

After the whey has been drained to the curd line, the residual whey may be drained from the vat with the jacket of the vat being kept warm. Draining the residual whey may be performed when the coagulated milk composition has a pH of about 5.65 to about 5.85. For example, draining the additional whey may be done when the coagulated milk composition has a pH of about 5.65, about 5.66, about 5.67, about 5.68, about 5.69, about 5.70, about 5.71, about 5.72, about 5.73, about 5.74, about 5.75, about 5.76, about 5.77, about 5.78, about 5.79, about 5.80, about 5.81, about 5.82, about 5.83, about 5.84, or about 5.85.

Removing the whey from the coagulated milk composition may include washing the coagulated milk composition. Washing may help to control the pH of the coagulated milk composition. In some embodiments, the curds may be washed with water to remove whey, as well as lactose from the coagulated milk composition. The rinsing water may be from about 90° F. and to about 100° F. Rinsing the coagulated milk composition may be done when the coagulated milk composition has a pH of about 5.60 to about 5.75. For example, rinsing the coagulated milk composition may be done when the coagulated milk composition has a pH of about 5.60, about 5.61, about 5.62, about 5.63, about 5.64, about 5.65, about 5.66, about 5.67, about 5.68, about 5.69, about 5.70, about 5.71, about 5.72, about 5.73, about 5.74, or about 5.75.

i. Addition of Salt

The method may also include adding salt to the coagulated milk composition. The addition of salt to the coagulated milk composition may help lower the moisture content, as well as control the pH of the coagulated milk composition. The coagulated milk composition may be salted in the vat (following removal of the whey) and/or placed on a table and then salted. Salt substitutes are not used in the disclosed method. In some embodiments, the salt consists of NaCl. The amount of salt added to the coagulated milk composition may be about 1.7 wt % to about 2.5 wt % of the total weight of the coagulated milk composition. For example, the amount of salt added to the coagulated milk composition may be about 1.7 wt %, about 1.8 wt %, about 1.9 wt %, about 2.0 wt %, about 2.1 wt %, about 2.2 wt %, about 2.3 wt %, about 2.4 wt %, or about 2.5 wt %. In some embodiments, the amount of salt added to the coagulated milk composition is about 1.8 wt % to about 1.9 wt %.

Salt may be added to the coagulated milk composition in installments. For example, salt may be added in at least 1 installment, at least 2 installments, at least 3 installments, at least 4 installments, at least 5 installments, at least 6 installments, or at least 7 installments. In some embodiments, salt may be added in less than 7 installments, less than 6 installments, less than 5 installments, less than 4 installments, less than 3 installments, or less than 2 installments. In some embodiments, salt is added in 3 installments.

In addition, the salt may be added in installments separated by a period of time. For example, installments may be separated by about 1 minute, about 5 minutes, about 10 minutes, about 15 minutes, about 20 minutes, or combinations thereof. In some embodiments, the salt may be added in 3 installments, wherein the installments are separated by about 15 minutes.

Adding salt to the coagulated milk composition may be done when the coagulated milk composition has a pH of from about 5.45 to about 5.7. For example, adding salt may be done when the coagulated milk composition has a pH of about 5.45, about 5.46, about 5.47, about, 5.48, about 5.49, about 5.50, about 5.51, about 5.52, about 5.53, about 5.54, about 5.55, about 5.56, about 5.57, about 5.58, about 5.59, about 5.60, about 5.61, about 5.62, about 5.63, about 5.64, about 5.65, or about 5.7.

j. Pressing

The method may also include pressing the coagulated milk composition. Pressing of the coagulated milk composition may be performed on machines that are known within the art. Pressing the coagulated milk composition may be performed for about 1 hour to about 5 hours. For example, pressing the coagulated milk composition may be performed for about 1 hour, 2 hours, 3 hours, 4 hours or 5 hours. Additionally, pressing the coagulated milk composition may be performed at variable pressures for the aforementioned lengths of time. For instance, pressing the coagulated milk composition may be performed at about 30 PSI to about 80 PSI, or about 30 PSI, about 40 PSI, about 50 PSI, about 60 PSI, about 70 PSI, or about 80 PSI. In some embodiments, the coagulated milk composition is pressed for about 4 hours at about 60 PSI using a horizontal press.

Pressing the coagulated milk composition may be done when the coagulated milk composition has a pH of about 5.15 to about 5.5. For example, pressing may be done when the coagulated milk composition has a pH of about 5.15, about 5.16, about 5.17, about 5.18, about 5.19, about 5.20, about 5.21, about 5.22, about 5.23, about 5.24, about 5.25, about 5.3, about 5.35, about 5.4, about 5.45 or about 5.5.

In some embodiments, the coagulated milk composition may be pressed about 75 minutes to about 95 minutes, about 80 minutes to about 90 minutes, or about 85 minutes after the coagulated milk composition is cooked. Following pressing, a melt-restricted, natural cheese is provided.

k. Sealing/Aging

The method may also include sealing and aging the melt-restricted, natural cheese. Sealing and aging (e.g., ripening) can instill the appropriate flavor profiles of the resultant melt-restricted, natural cheese. Aging may be done after the melt-restricted, natural cheese has been made. The melt-restricted, natural cheese may be aged for about 2 weeks to about 1 year, for about 30 days to about 1 year, or for about 30 days to about 150 days. For example, the melt-restricted, natural cheese may be aged for about 14 days, about 30 days, about 60 days, about 90 days, about 150 days, about 200 days, about 250 days, about 300 days, or about 360 days.

In addition, the melt-restricted, natural cheese may be aged at an appropriate temperature during the aging process. For example, the melt-restricted, natural cheese may be aged at a temperature of about 30° F. to about 45° F. In some embodiments, the melt-restricted, natural cheese is aged at a temperature of about 40° F.

l. Additional Steps

The method may also include additional steps, which can be used to further process the milk composition, the coagulated milk composition and/or the melt-restricted, natural cheese. For example, additional ingredients may be added to the milk composition, coagulated milk composition and/or the melt-restricted, natural cheese. Additional ingredients may be ingredients that impart the appropriate flavor profile to the melt-restricted, natural cheese and still provide a natural cheese. Examples include, but are not limited to, serrano peppers, siracha peppers, red bell peppers, fruits, chili seasoning and dairy flavors. The resultant cheese may be capable of being formed and/or sliced.

m. pH

The method may regulate the pH throughout the process of making the melt-restricted, natural cheese. It may be useful to lower the pH throughout the cheese making process in an appropriate manner over an appropriate time period. For example, the pH of the milk composition and/or coagulated milk composition may drop at a rate of from about 0.175 to about 0.20/hour during the method.

The pH of the method can be modulated by a number of different techniques such as, but not limited to, type of salt-sensitive cultures used, length of time that the milk composition is contacted with the at least one salt sensitive culture, and the addition of salt.

### 4. USE OF THE MELT-RESTRICTED, NATURAL CHEESE

The melt-restricted, natural cheeses may be used in a number of applications. Specifically, the melt-restricted, natural cheese may be used in food applications where a natural cheese is needed to maintain its form at temperatures above which conventional natural cheeses would typically flow.

The melt-restricted, natural cheese may be used as a cheese that can be baked or grilled. Additionally, the melt-restricted, natural cheese may be used within meat products, for example, meat patties, encased meats (e.g., sausage), turkey and/or chicken.

The melt-restricted, natural cheese may be used to replace carbohydrate-based products. For instance, the melt-restricted, natural cheese may be used to replace tortilla shells, pizza crust, buns for hot dogs and hamburgers, breads, flatbreads, or pitas. The melt-restricted, natural cheese may serve as a higher protein, lower carbohydrate alternative to carbohydrate-based products. For example, a comparison of nutritional information for the melt-restricted, natural cheese and other food products is presented in Table 1 below.

TABLE 1
Comparison of the Melt-Restricted, Natural Cheese

| Natural Cheeses | | | | Process | Other Protein | | | | | |
|---|---|---|---|---|---|---|---|---|---|---|
| | Melt- | | | Cheese | Sources | | Other Potential Replacement | | | |
| | Restricted. | Natural | RF | Restricted | Cooked | Cooked | | Whole | | |
| | Natural | Cheddar | Cheddar | Melt | Chicken | Ground | Flour | Wheat | Cooked | Pizza |
| | Cheese | Cheese | Cheese | Cheddar | Breast | Beef | Tortilla | Tortilla | Fettuccine | Crust |
| Calories | 332 | 403 | 283 | 375 | 117 | 276 | 297 | 289 | 157 | 331 |
| (cal.) | | | | | | | | | | |
| Fat (g) | 24.0 | 33.9 | 18.9 | 31.25 | 3.2 | 18.6 | 8.1 | 6.7 | .90 | 4.85 |
| Carbs. (g) | 1.9 | 1.6 | 2.1 | 1.6 | 1.0 | 0 | 48.6 | 48.9 | 30.7 | 63.4 |
| Protein (g) | 27.0 | 22.7 | 26.1 | 22.15 | 21.05 | 25.35 | 5.4 | 8.9 | 5.8 | 7.7 |
| g and % | 0 | 4.3 g, | 0.9 g, | 4.85 g, | 5.95 g, | 1.65 g, | 21.6 g, | 18.1 g, | 21.2 g, | 19.3 g, |
| Protein | | 19% | 3.5% | 22% | 28.3% | 6.5% | 400% | 203% | 365% | 251% |
| higher in | | | | | | | | | | |
| melt- | | | | | | | | | | |
| restricted, | | | | | | | | | | |
| natural | | | | | | | | | | |
| cheese | | | | | | | | | | |
| Moisture | 42.5 | 38.2 | 48.6 | 40.0 (Max) | 73.7 | 54.6 | | | | |
| (g) | | | | | | | | | | |

The present invention has multiple aspects, illustrated by the following non-limiting examples.

### 5. EXAMPLES

### Example 1

### Production and Characterization of Melt-Restricted, Natural Cheeses—1

Described below is the production and characterization of exemplary embodiments of the disclosed melt-restricted, natural cheese.

Production: Specifically, raw milk is provided to prepare 500 lbs of final product, and is then standardized for appropriate fat:casein ratios. For example, Vat 2 had 1252 lbs of skim, 93 lbs of cream, and 150 lbs of water; while Vat 3 had 2021 lbs of skim, 149 lbs of cream and 241 lbs of water. Vat 4 produced a disclosed melt-restricted, natural cheese. Vat 5 was a standard make queso blanco and Vat 6 was a standard make paneer cheese, both of which were control cheeses.

Vats 1-4: The milk composition contained 2.25-2.45% fat content, approximately 2.5% casein, resulting in a fat:casein ratio of 0.9 to 1.0. Prior to pasteurization, Vats 2 and 3 were homogenized (1^{st} stage: 1200 psi; 2^{nd} stage: 500 psi). Samples were then pasteurized via high temperature, short time (HTST) at 164° F. (Vat 1, 2 and 3), 174° F. (Vat 3) or 185° F. (Vat 4) for 19 seconds. Following pasteurization, starter cultures were added to the samples (Chr Hanson S. therm A-2090 & Chr. Hanson S. therm CR-319) and were allowed to incubate at approximately 93° F. to 95° F., with pH being monitored during this time period. Calcium chloride and rennet (Chymax M) were added subsequently to the culture. Once the sample achieved the desired pH and firmness, the sample was allowed to rest and was then cut. Next, the sample was cooked at a temperature of approximately 110° F. to 115° F. for about 30 minutes. At the conclusion of the cooking step, the sample was drained of residual whey via first draining the sample to the curd line and then draining the balance of the whey. The sample was then allowed to rest on a table until the pH reached approximately 5.6. Salt was then added in 2 installments, which were 15 minutes apart from each other and allowed the pH to drop slowly. Samples were then hooped and pressed (4h at 60 psi). Finally, the samples were placed under a vacuum seal and allowed to age accordingly, depending on the desired final product.

Two weeks after production, the cheeses were characterized by fat content, moisture content, pH, salt(chloride) content, protein content, lactose/galactose content, and plating. For example, Vat 4 produced a cheese that had a moisture content of 38.35%, fat content of 26.47%, protein content of 29.52%, salt content of 2.19%, and pH of 5.4.

Shelf-Life: Each cheese was analyzed for organoleptic characteristics, for example, flavor, texture and appearance. Cheese was analyzed using a 0.66 oz slice of said cheese, and was kept frozen or refrigerated until day of analysis, wherein frozen samples were thawed one day prior to analysis. Analysis was performed by placing slices of cheese (frozen and refrigerated) side-by-side in a pan over a medium/large burner, and allowed to fry for 30 seconds on each side for a total time of 1 minute. Results of the shelf-life analysis are presented in Table 2-3, wherein Day X denotes days after the cheese was made. For example, day 69 denotes 69 days after making the cheese being analyzed.

TABLE 2
Shelf-Life Characterization of Cheeses (Vat 1-3) from Example 1

| Vat 1 | Vat 2 | Vat 3 |
|---|---|---|
| Day 69: Refrigerated-peel | Day 69: Refrigerated-pan per- | Day 69: Best to handy |
| good & fresh curd. Melts the | formed better than frozen & | keeping in shape Frozen- |
| most. Frozen-little hard to | slice kept its shape Frozen- | More crumbly(brittle) |
| handy & peels good & more | More crumbly(brittle) | |
| crumbly | | |
| Day 104: Control didn't fry | Day 104: nice browning nice | Day 104: nice browning nice |
| well, breaking down not | flavor & kept it shape | flavor & kept it shape |
| browning | | |
| Day 133: Frozen(Thawed)- | Day 133: Frozen(Thawed)- | Day 133: Frozen(Thawed)- |
| peels good, thawed good. | peeling & thawed ok. Good | peeling & thawed fine. Not |
| Golden brown didn't keep its | flavor, not breaking up | breaking up. Mild flavor, |
| shape. Refrigerated(Control)- | Darker brown & didn't keep | alittle stretch, kept its shape |
| Stringy & Stretchy burnt | its shape. | slight squeaky Golden brown. |
| Day 161: both frozen & | Day 161: Refrigerated- | Day 161: Frozen-kept its |
| refrigerated melting away, | melting away didn't brown, | shape. Refrigerated- melting |
| Frozen darker brown and | Frozen-slightly less melted | better kept its shape Frozen |
| Refrigerated golden brown | and less brown Frozen | darker brown and |
| | darker brown and | Refrigerated golden brown |
| Day 195: Refrigerated-better | | Day 195: Refrigerated-Didn't |
| flavor Frozen-Brittle. Frozen- | | brown. Frozen-more sugars. |
| more sugars. All kept is | | All kept is shape. |
| shape. | | |

TABLE 3
Shelf-Life Characterization of Cheeses (Vat 4-6) from Example 1

| Vat 4 | Vat 5 | Vat 6 |
|---|---|---|
| Day 69: Cracked/dried up | Day 69: a lot of break down | Day 69: doesn't move when |
| more Frozen-More | Frozen-More crumbly(brittle) | melted, More darker than |
| crumbly(brittle) | | others Frozen-More |
| | | crumbly(brittle) |
| Day 104: Nice Browning, | Day 104: Didn't keep its | Day 104: Held its shape, |
| More chewy & kept it shape | shape, body soft in mouth, | brown good, milky flavor soft |
| | stuck to pan. Slice was not | texture |
| | thawed, chalky | |
| Day 133: Frozen(thawed)- | Day 133: Frozen(thawed)-has | Day 133: Peeling ok not |
| Slices are breaking, cracking | moist, peels ok Didn't keep its | breaking Thawed ok. You |
| in the middle. Chewy and | shape, melted away | can handle it. Good milky |
| drier. Held its shape golden | Burnt/darker color. Very | flavor. Not melting keeping it |
| brown. Refrigerated(control)- | salty Refrigerated(control)- | shape good flavor. Not dry, |
| Day 161: frozen-when | Day 161: Both very moist. | Day 161: Refrigerated kept |
| handing it starts to break but | Really dark and brown | its shape. Frozen-nice clean |
| fry the cheese it kept its | patches Melting away. | flavor slight sour. Both you |
| shape. Refrigerated-kept its | Frozen darker brown and | can bend it. Frozen darker |
| shape. Both you can bend it. | Refrigerated golden brown | brown and Refrigerated |
| Day 195: Refrigerated-Didn't | | Day 195: Both Refrigerated |
| brown as much as the frozen, | | & Frozen-kept its shape sour |
| nice chewy and more flavor | | flavor Frozen-more sugars. |
| than frozen product. More | | All kept is shape. |
| burnt flavor. Frozen-more | | |

### Example 2

### Production and Characterization of Melt-Restricted, Natural Cheeses—2

Described below is the production and characterization of exemplary embodiments of the disclosed melt-restricted, natural cheese. Some of the Vats prepared cheese with additional natural flavors, e.g., Vat 3: pepper and Vat 4: seasoned.

Production: Specifically, raw milk is provided to prepare 500 lbs of final product, and is then standardized for appropriate fat:casein ratios. For example the milk composition of Vat 2 included a 9.57% solids content, 2.15% fat content, 2.37% true protein, 1.98% casein, and a resultant fat:casein ratio of 1.085. Of note, samples were not homogenized. Samples were then pasteurized via high temperature, short time (HTST) at either 175° F. (Vat 1) or 185° F. (Vats 2-6) for 19 seconds. Following pasteurization, starter cultures were added to the samples (Vats 1-6: Chr Hanson S. therm A-2090 & Chr. Hanson S. therm CR-319; Vat 5 additionally had Chr Hanson CR-213; and Vat 6 additionally had Cargill RF-4 & Cargill CRF-1) and were allowed to incubate at approximately 93° F. to 96° F. for about 1.5 hours, with pH being monitored during this time period. Calcium chloride and rennet (Chymax M) were added subsequently to the culture, but within the 4 hour incubation time. Once the sample achieved the desired pH, the sample was allowed to rest and was then cut. Next, the sample was cooked at a temperature of approximately 110° F. to 115° F. for about 30 minutes. At the conclusion of the cooking step, the sample was drained of residual whey via first draining the sample to the curd line and then draining the balance of the whey. The sample was then allowed to rest on a table until the pH reached approximately 5.5-5.6. Salt was added in 3 installments, which were 15 minutes apart from each other and allowed the pH to drop slowly. Then the samples were hooped and pressed (4 hours at 60 psi in a horizontal press). Finally, the samples were placed under a vacuum seal and allowed to age accordingly, depending on the desired final product.

Two weeks after production, the cheeses were characterized by fat content, moisture content, pH, salt(chloride) content, protein content, and plating. For example, Vat 2 produced a cheese that had a moisture content of 39.15%, fat content of 27.1%, protein content of 28.34%, salt content of 2.37%, and pH of 5.3.

Shelf-life: Each cheese was analyzed for organoleptic characteristics, for example, flavor, texture and appearance. Cheese was analyzed using a 1.75-1.80 oz round slice of said cheese, and was kept refrigerated until day of analysis. Analysis was performed by placing slices of cheese on a griddle at 350° F. for 1 minute, with about 30 seconds per side. Results of the shelf-life analysis are presented in Table 4-5, wherein Day X denotes days after the cheese was made. For example, day 69 denotes 69 days after making the cheese being analyzed.

TABLE 4
Shelf-Life Characterization of Cheeses (Vat 1-3) from Example 2

| Vat 1 | Vat 2 | Vat 3 |
|---|---|---|
| Day 26: didn't keep its | Day 26: Worked just fine, | Day 26: Good flavor(Pepper) |
| shape(on griddle), good | browned up nice. Kept its | but not hot browned up nice. |
| flavor. Skillet(medium heat) | shape | Slightly crumbly. Kept its |
| more melting. Browned up | | shape |
| nice | | |
| Day 70: more melted not | Day 70: same | Day 70: good flavor & |
| keeping its shape | | texture. Kept its shape. Heat |
| | | as increased. Good body |
| Day 105: same melting as | Day 105: firmer body. Kept | Day 105: Kept its shape. |
| Day 70, soft and chewy | its shape. | Body same as #2. Nice |
| | | Jalapeno flavor. Good body |
| Day 138: same melting as | Day 138: didn't keep its | Day 138: Kept its shape. |
| before | shape. Soft and melting. | Good flavor |
| | Good flavor | |
| | Day 168: kept its shape. | Day 168: kept its shape. |
| | Flavor- mild, no dairy notes, | Flavor- more pepper flavor |
| | toasty note. More browning | |
| | than 6. | |

TABLE 5
Shelf-Life Characterization of Cheeses (Vat 4-6) from Example 2

| Vat 4 | Vat 5 | Vat 6 |
|---|---|---|
| Day 26: good flavor, browned | Day 26: more buttery, milder, | Day 26: more buttery, milder, |
| up nice. Slightly crumbly. | less salty & more flavor than | less salty & more flavor than |
| Kept its shape | control browned up nice. | control browned up nice. |
| | Slightly crumbly. Kept its | Slightly crumbly. Kept its |
| | shape | shape |
| Day 70: good flavor | Day 70: less browning than | Day 70: same flavor good |
| | Day 26 taste good | |
| Day 105: browned up nice | Day 105: melting more. | Day 105: lighter color more |
| better than #3. nice body to | Chewy & softer body. | melting than #2. more dairy |
| the cheese. Kept its shape. | | note. |
| Nice nacho taco seasoning. | | |
| Day 138: kept its shape. | Day 138: melting more. | Day 13 8: milky flavor. Didn't |
| Good flavor | Didn't keep its shape. chewy | keep its shape. |
| | & softer body. Flavor dairy | |
| | note. flavor-yeast | |
| Day 168: kept its shape. | Day 168: melting more. | Day 168: melting more. |
| Flavor-good. (more saltness | More butter flavor | Flavor-different. Milky |
| than taco flavor) Body- | | flavor. |
| Good | | |

### Example 3

### Production and Characterization of Melt-Restricted, Natural Cheeses—3

Described below is the production and characterization of exemplary embodiments of the disclosed melt-restricted, natural cheese.

Production: Specifically, raw milk is provided to prepare 500 lbs of final product, and is then standardized for appropriate fat:casein ratios. Milk content is described in Table 6. Samples were then pasteurized via high temperature, short time (HTST) at 185° F. for 19 seconds. Following pasteurization, starter cultures were added to the samples (Chr Hanson S. therm A-2090 & Chr. Hanson S. therm CR-319) and were allowed to incubate at approximately 93° F. to 96° F. for about 1.5 hours, with pH being monitored during this time period. Calcium chloride and rennet (Chymax M) were added subsequently to the culture, but within the 4 hour incubation time. Once the sample achieved the desired pH, the sample was allowed to rest and was then cut. Next, the sample was cooked at a temperature of approximately 110° F. to 115° F. for about 30 minutes. At the conclusion of the cooking step, the sample was drained of residual whey via first draining the sample to the curd line and then draining the balance of the whey. The sample was then allowed to rest on a table until the pH reached approximately 5.5-5.6. Salt was added in 3 installments, which were 15 minutes apart from each other and allowed the pH to drop slowly. Samples were then hooped and pressed (4 hour 60 psi in a horizontal press). Finally, the samples were placed under a vacuum seal and allowed to age accordingly, depending on the desired final product.

TABLE 6
Milk Characterization of Example 3

| Pre Blend Information | | |
|---|---|---|
| (Day Before) | Raw Cream | Raw Skim |
| % Solids | 34.19 | 8.83 |
| % Fat (Mojonnier) | 27.86 | 0.07 |
| % Crude Protein (N × 6.35) | 2.20 | 3.06 |
| % True Protein (N × 6.35) | 2.07 | 2.87 |
| % Casein (N × 6.36) | 1.64 | 2.39 |
| % Casein to Crude Protein Ratio | 74.55 | 78.10 |
| % Casein to True Protein Ratio | 79.23 | 83.28 |
| Casein to Fat Ratio | 0.06 | 34.14 |
| Milk Information (Day of) | Raw | Pasteurized milk |
| % Solids | 11.97 | 11.40 |
| % Fat (Mojonnier) | 2.25 | 2.15 |
| % Crude Protein (N × 6.35) | 3.44 | 3.26 |
| % True Protein (N × 6.35) | 3.24 | 3.08 |
| % Casein (N × 6.36) | 2.70 | 2.70 |
| % Casein to Crude Protein Ratio | 78.49 | 82.82 |
| % Casein to True Protein Ratio | 83.33 | 87.66 |
| Casein to Fat Ratio | 1.20 | 1.25 |
| Milk Micro Information | milk transfer line | Pasteurized milk |
| Coliform (VRB; CFU/ml) | <1 | <1 |
| Total Plate Count (SPC; CFU/ml) | 136 | 57 |
| Lactobacillus (Rogosa SL; | <1 | <1 |
| CFU/ml) | | |

Two weeks after production, the cheeses were characterized by fat content, moisture content, pH, salt(chloride) content, protein content, and plating. The cheese characterization is presented in Table 7.

TABLE 7
Cheese Characterization of Example 3

| | | | Vat 3 | | Vat 4 | Vat 5 | Vat 6 |
|---|---|---|---|---|---|---|---|
| | Vat 1 | Vat 2 | Melt- | | Melt- | Melt- | Melt- |
| | Melt- | Melt- | restricted, | | restricted, | restricted, | restricted, |
| | restricted, | restricted, | yellow cheese | | white cheese | white cheese | white cheese - |
| | low salt cheese | white cheese | with dairy flavors | | with serrano | with sriracha | shear pump |
| Cheese Composition @ 2 | 0.000 | 0.000 | 3A | 3B | 0.000 | 0.000 | 0.000 |
| Weeks (from FT) | | | | | | | |
| % Moisture | 42.30 | 41.90 | 44.40 | 44.10 | 42.60 | 41.20 | 41.70 |
| % Fat (Mojonnier) | 22.30 | 22.75 | 21.25 | 21.50 | 21.50 | 23.00 | 22.00 |
| % Salt | 1.34 | 1.82 | 1.98 | 1.78 | 1.94 | 1.82 | 1.74 |
| % Crude Protein (N × 6.38) | 30.18 | 29.57 | 26.85 | 26.85 | 29.58 | 30.82 | 30.11 |
| Component Total | 96.12 | 96.04 | 94.48 | 94.23 | 95.62 | 96.84 | 95.55 |
| % Moisture in Nonfat | 54.44 | 54.24 | 56.38 | 56.18 | 54.27 | 53.51 | 53.46 |
| Substance | | | | | | | |
| % Fat in the Dry Matter | 38.65 | 39.16 | 38.22 | 38.46 | 37.46 | 39.12 | 37.74 |
| % Salt as a Percentage of | 3.17 | 4.34 | 4.46 | 4.04 | 4.55 | 4.42 | 4.17 |
| the Moisture Phase | | | | | | | |
| Cheese pH | 0.00 | 0.00 | 3A | 3B | 0.00 | 0.00 | 0.00 |
| 2 Weeks | 5.38 | 5.43 | 5.37 | 5.37 | 5.46 | 5.37 | 5.38 |
| Cheese Micro @ 2 Weeks | 0.00 | 0.00 | 082014-3A | 082014-3B | 0.00 | 0.00 | 0.00 |
| Coliforms (VRB; CFU/g) | <10 | <10 | <10 | <10 | <10 | <10 | <10 |

### Example 4

### Production and Characterization of Melt-Restricted, Natural Cheeses—4

A melt-restricted, natural cheese was made by processes as disclosed herein.

The cheese characterization is presented in Table 8 along with characterization of sample cheeses described in Examples 1-3.

TABLE 8
Cheese Characterization of samples from Examples 1-4

| | | | Example 3 | |
|---|---|---|---|---|
| | | | melt- | |
| | | | restricted, | |
| | Example 1 | Example 2 | white cheese | Example 4 |
| Milk Composition | | | | |
| Total Solids | | 9.57% | 11.40% | 14.22% |
| Fat | 2.2-2.3% | 2.15% | 2.15% | 3.10% |
| True Protein | | 2.37% | 3.08% | 4.23% |
| Casein | ^{~}2.5% | 1.98% | 2.70% | 3.30% |
| Fat:Casein Ratio | 0.9 | 1.085 | 0.8 | 0.94 |
| Cheese Composition | | | | |
| Moisture | 38.35% | 39.15% | 41.90% | 42.5% |
| Total Solids | 61.65% | 60.85% | 58.10% | 57.50% |
| Fat | 26.47% | 27.10% | 22.75% | 24.0% |
| Protein | 29.52% | 28.34% | 29.57% | 27.0% |
| Salt | 2.19% | 2.37% | 1.82% | 2.20% |
| pH | 5.40 | 5.30 | 5.43 | 5.32 |
| FDM | 42.94% | 44.53% | 39.15% | 41.74% |
| % NaCl in | 5.74% | 6.00% | 4.34% | 5.18% |
| Moisture phase | | | | |

### Example 5

### Melt Testing (“Melt Test 1”)

Described below is the procedure for determining the melt quality/characteristics of a cheese.

Each melt test was performed by heating a 0.5 inch cheese plug on a glass petri dish (Pyrex® petri dish at 15×60 mm) and without the petri dish cover in an electric oven. The cheese plug may be obtained with a 0.5 inch cork borer. The cheese plug is cut to ⅛ inch thickness and placed in the center of the petri dish.

The oven temperature is verified to be 400° F. ±25° F. Place the cheese plug-containing petri dish onto a metal baking tray on the center rack of oven and set timer for 5 minutes. After 5 minutes, remove baking tray and then remove petri dish from baking tray. The petri dish is then placed onto a flat surface and allowed to cool at room temperature for 10 to 15 minutes.

The cheese melt, or flow, is determined by measuring spread diameter and area (e.g., melt spread). The spread diameter is measured using concentrically numbered target-type templates placed face up on the bottom of the petri dishes. The diameter of the innermost circle is 9/16 inch and the diameter of each subsequent circle is increased by ⅛ inch. The circles are numbered from 1 to 5 starting from the smallest. At the start of the melt test, the cheese plug fits inside the circle “1”. The melt indicia (e.g., melt range which is used interchangeably with melt spread) measured is the melt to the nearest circle that the cheese sample covers. A cheese has a melt spread of “1” if the sample does not spread at all.

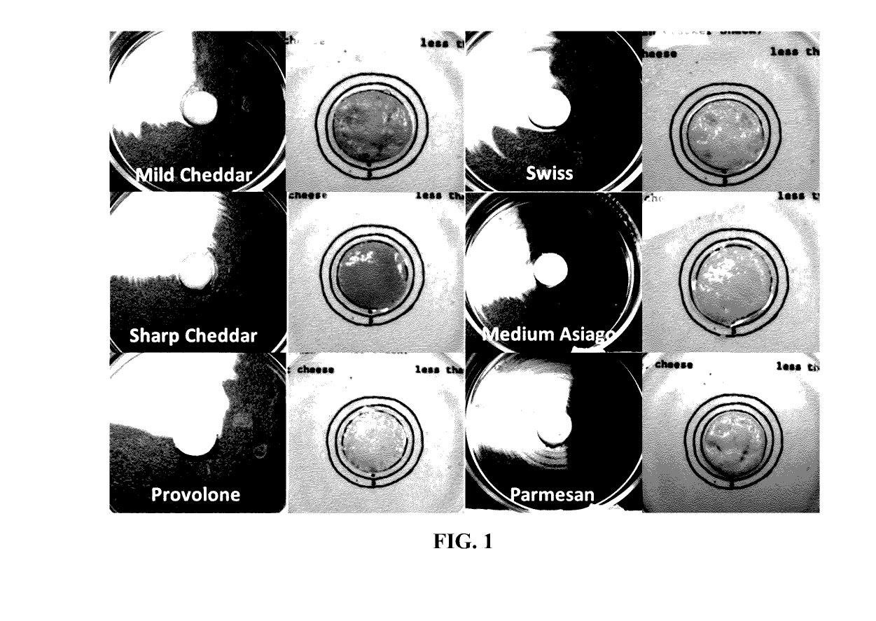

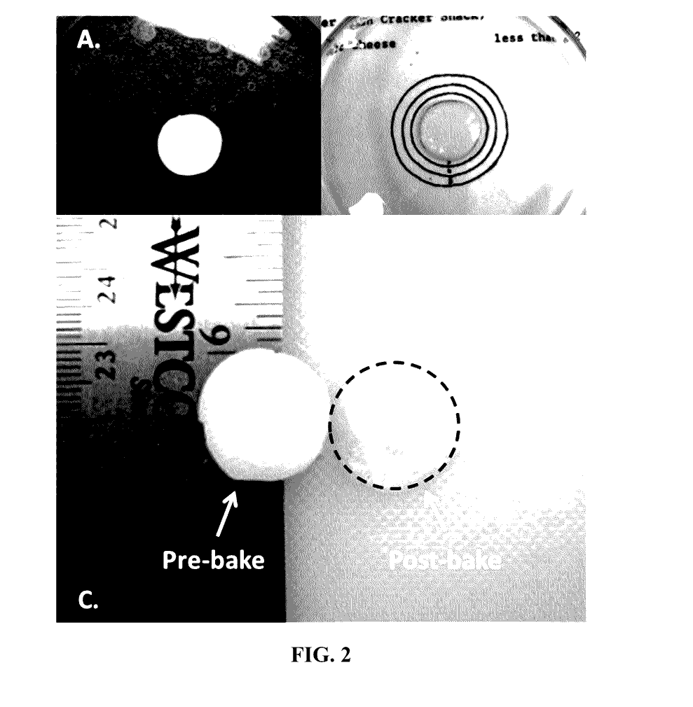

The aforementioned melt test was used to evaluate melt characteristics of conventional natural cheeses and disclosed melt-restricted, natural cheeses (FIGS. 1 and 2). This evaluation is shown below in Table 9.

TABLE 9
Cheese Characterization

| | Mild Cheddar | Sharp Cheddar | Disclosed Cheese |
|---|---|---|---|
| Chemical | Moisture: 37.82% | Moisture: 37.23% | Moisture: 42.50% |
| Composition | Fat: 33.30% | Fat: 32.40% | Fat: 24.0% |
| | FDB: 53.60% | FDB: 51.60% | FDB: 41.74% |
| | pH: 5.17 | pH: 5.10 | pH: 5.32 |
| | Salt: 1.73% | Salt: 1.72% | Salt: 2.20% |
| | % NaCl in | % NaCl in | % NaCl in |
| | moisture phase: | moisture phase: | moisture phase: |
| | 4.57% | 4.61% | 5.18% |
| Melt | 3 to 4 | 3 to 4 | 2 |
| Range | | | |

| | Provolone | Swiss |
|---|---|---|
| Chemical | Moisture: 43.6% | Moisture: 37.9% |
| Composition | Fat: 27.30% | Fat: 31.05% |
| | FDB: 48.37% | FDB: 50.02% |
| | pH: 5.16 | pH: 5.25 |
| | Salt: 1.58% | Salt: 0.8% |
| | % NaCl in | % NaCl in |
| | moisture phase: | moisture phase: |
| | 3.63% | 2.10% |
| Melt | 3 | 3 to 4 |
| Range | | |
| | Medium Asiago | Parmesan |
| Chemical | Moisture: 34.07% | Moisture: 30.93% |
| Composition | Fat: 31.35% | Fat: 27.31% |
| | FDB: 47.55% | FDB: 39.54% |
| | pH: 5.10 | pH: 5.21 |
| | Salt: 2.25% | Salt: 2.26% |
| | % NaCl in | % NaCl in |
| | moisture phase: | moisture phase: |
| | 6.60% | 8.63% |
| Melt | 3 to 4 | 3 to 4 |
| Range | | |

### Example 6

### Shelf-Life Evaluation

A melt-restricted, natural cheese was made by processes described herein. The melt-restricted, natural cheese was then evaluated for shelf-life characterization.

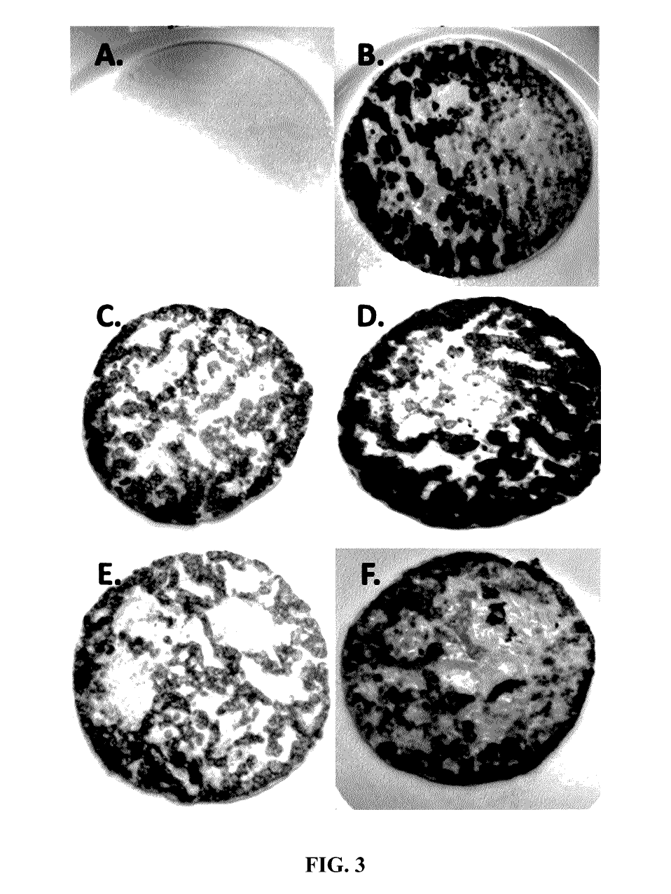

The shelf-life evaluation was performed on a slice of cheese having a weight of approximately 45 g and aged for a specified period of time (e.g., 30 days, 60 days, 90 days, etc.) after being made. Characteristics of the cheese were evaluated by placing two slices of the sample cheese on a Presto Tilt‘n’Drain™ Griddle at 350° F. for 3 min (1 min 30 sec per side). Then the following observations were made: ease of handling while flipping the slice; appearance (e.g., change in the dimension due to melt) and color (e.g., brown or burn spots, bubbles etc); flavor (e.g., changes in flavor due to aging/ripening); and texture (e.g., break down of body, chewiness). Analysis of the varied aged cheese slices demonstrated similar melt characteristics for disclosed cheeses aged from 30 days to at least about 150 days. Observations of this analysis can be seen in FIG. 3.

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

What is claimed is:

1. A melt-restricted, natural cheese comprising a pH of less than 6.

2. The cheese of claim 1, further comprising protein in an amount of about 20 wt % to about 40 wt %.

3. The cheese of claim 1, further comprising salt in an amount of about 1.0 wt % to about 2.5 wt %.

4. The cheese of claim 1, further comprising fat in an amount of about 15 wt % to about 30 wt %.

5. The cheese of claim 1, wherein the cheese has a melt spread of less than 3 as verified by Melt Test 1.

6. The cheese of claim 1, wherein the pH is from greater than 4.6 to about 5.6.

7. The cheese of claim 1, further comprising a fat content that has not been homogenized.

8. A melt-restricted, natural cheese comprising:
a pH of from greater than 4.6 to about 5.6;
protein in an amount of about 26 wt % to about 32 wt %;
salt in an amount of about 1.7 wt % to about 2.4 wt %;
fat in an amount of about 20 wt % to about 28 wt %;
a moisture content in an amount of about 38 wt % to about 45 wt %; and
salt in the moisture phase in an amount of about 4 wt % to about 6 wt %.

9. A method for making a melt-restricted, natural cheese, the method comprising:
(a) providing a milk composition with a fat:casein ratio of from about 0.8 to about 1.2;
(b) heating the milk composition at a temperature from about 180° F. to about 190° F.;
(c) contacting the milk composition with at least one salt-sensitive culture and a low proteolytic enzyme for a period of time to form a coagulated milk composition;
(d) cooking the coagulated milk composition at a temperature from about 110° F. to about 120° F.;
(e) removing the whey from the coagulated milk composition; and
(f) salting and pressing the coagulated milk composition to provide a melt-restricted, natural cheese.

10. The method of claim 9, wherein the melt-restricted, natural cheese has a pH from greater than 4.6 to about 5.6 and is melt-restricted as verified by Melt Test 1.

11. The method of claim 9, wherein the milk composition has a solids content of about 8 wt % to about 16 wt %.

12. The method of claim 9, wherein the milk composition is not homogenized.

13. The method of claim 9, wherein the fat:casein ratio is about 0.9.

14. The method of claim 9, wherein the milk composition of step (b) is heated at a temperature of about 185° F. for about 10 seconds to about 25 seconds.

15. The method of claim 9, wherein the at least one salt-sensitive culture is selected from the group consisting of: a mesophilic culture, a thermophilic culture, and combination thereof.

16. The method of claim 9, wherein the milk composition is contacted with the low proteolytic enzyme for about 50 minutes to about 70 minutes after the milk composition is contacted by the at least one salt-sensitive culture.

17. The method of claim 9, wherein the coagulated milk composition is formed about 80 minutes after contacting the milk composition with the at least one salt-sensitive culture.

18. The method of claim 9, wherein the coagulated milk composition is washed following removal of the whey.

19. The method of claim 9, wherein the pH drops from about 0.175 to about 0.20 per hour from step (c) to step (f).

20. A melt-restricted, natural cheese made by the method of claim 9.
